(19) United States
(12) Patent Application Publication
(10) Pub. No.: US 2011/0219786 A1
(43) Pub. Date: Sep. 15, 2011

(54) FLUID HEAT SINK POWERED VAPOR CYCLE SYSTEM

(76) Inventors: Michael J. Andres, Roscoe, IL (US); Kris H. Campbell, Poplar Grove, IL (US)

(21) Appl. No.: 12/721,598

(22) Filed: Mar. 11, 2010

(51) Int. Cl. B64D 13/08; F25B 27/00; F25B 23/00; F25B 41/00

(52) U.S. Cl. 62/7; 62/238.1; 62/244; 62/506; 62/513

(57) ABSTRACT

An aircraft cooling system includes a refrigerant cycle including a first heat exchanger, a second heat exchanger, and a compressor. A component of the aircraft is in thermal communication with the first heat exchanger. A heat sink fluid passes through the second heat exchanger to absorb heat from the refrigerant cycle. A hydraulic motor is mechanically connected with the compressor and powered by the heat sink fluid, which is circulated by a pump.

### BACKGROUND

This application relates to an aircraft cooling system utilizing a vapor cycle.

Emerging aircraft contain a greater number of high power, high density electronic components that require cooling. Ram air has typically been used as a heat sink source in cooling applications. However, the drive to improve aircraft efficiency has decreased the availability of ram air for cooling applications.

### SUMMARY

An aircraft cooling system includes a refrigerant cycle including a first heat exchanger, a second heat exchanger, and a compressor. A component of the aircraft is in thermal communication with the first heat exchanger. A heat sink fluid passes through the second heat exchanger to absorb heat from the refrigerant cycle. A hydraulic motor is mechanically connected with the compressor and powered by the heat sink fluid, which is circulated by a pump.

These and other features of the present invention can be best understood from the following specification and drawings, the following of which is a brief description.

### BRIEF DESCRIPTION OF THE DRAWINGS

FIG. 1 shows a schematic view an example cooling system for an aircraft.

FIG. 2 shows a schematic view of another example cooling system for an aircraft.

### DETAILED DESCRIPTION

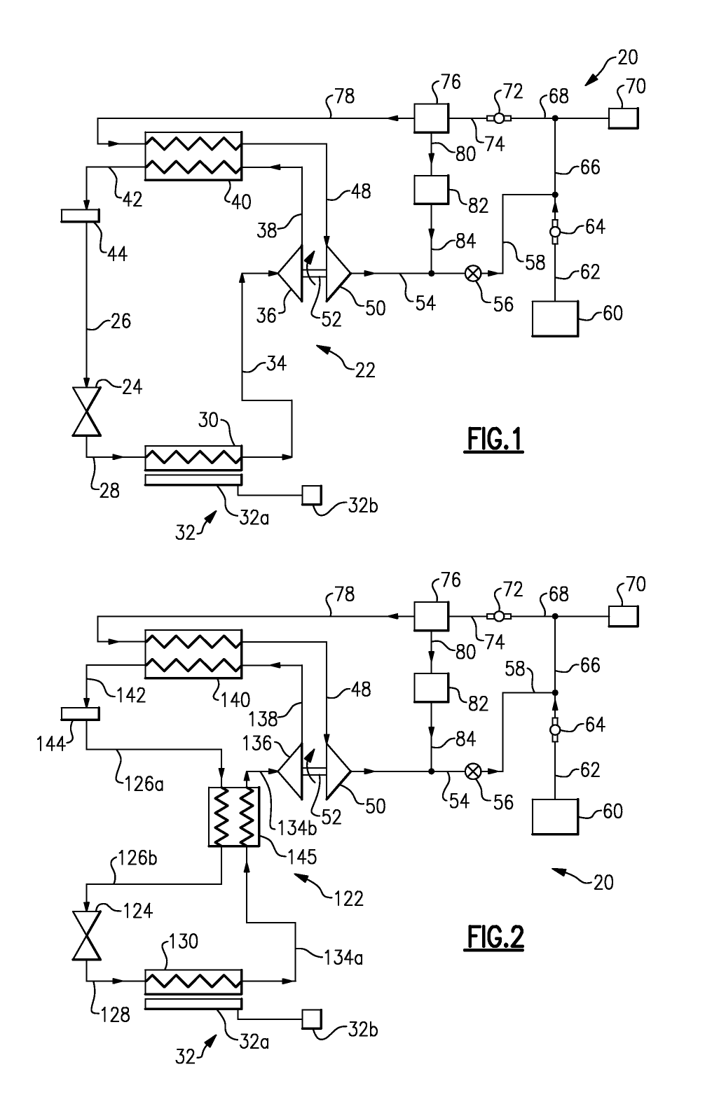

FIG. 1 shows an aircraft 20 having an example cooling system incorporating a vapor refrigerant cycle 22. The refrigerant may include any suitable refrigerant having an appropriate enthalpy of vaporization and boiling point within a reasonable pressure range for a desired application. An expansion device 24 receives warm high-pressure refrigerant from line 26. The expansion device 24 restricts the flow of the warm high-pressure refrigerant to produce low-pressure refrigerant exiting the expansion device 24 through line 28.

An evaporator 30 receives the low-pressure refrigerant from line 28. The evaporator 30 acts as a heat exchanger to remove heat generated by avionics 32. The avionics 32 include a first component 32a in electrical communication with a second component 32b. The first component 32a includes a motor controller or a power conditioning unit and the second component 32b includes a motor or a power generator, respectively. As the low-pressure refrigerant passes through the evaporator 30, the low-pressure refrigerant absorbs heat from the first component 32a. Heated low-pressure refrigerant exits the evaporator 30 through line 34.

A compressor 36 receives the heated low-pressure refrigerant from line 34 to be pressurized. The compressor 36 is mechanically connected to a hydraulic motor 50 through an output shaft 52. Superheated high-pressure refrigerant exits the compressor 36 through line 38.

A condenser 40 receives the superheated high-pressure refrigerant from line 38 and acts as a heat exchanger. As the superheated high-pressure refrigerant in line 38 passes through the condenser 40, heat is transferred to a heat sink fluid, such as aircraft engine fuel, that passes through line 78 in the condenser 40. Warm high-pressure refrigerant exits the condenser 40 through line 42 and passes through a filter-dryer 44 to remove water from the warm high-pressure refrigerant before entering the expansion device 24 again.

The heat sink fluid exits the condenser 40 through line 48 to power the hydraulic motor 50, such as a direct driven piston, diaphragm, turbine, or other similar hydraulic motor capable of producing a mechanical output from a pressurized fluid input. The hydraulic motor 50 is mechanically connected to the compressor 36 through the output shaft 52. As the heat sink fluid passes through the hydraulic motor 50 and into line 54, the output shaft 52 rotates to power the compressor 36 and pressurize the refrigerant in the vapor refrigerant cycle 22.

A primary pump 64, such as a constant delivery fuel pump, pumps the heat sink fluid and draws the heat sink fluid from the reservoir 60 into line 62. The heat sink fluid passes through the primary pump 64 and into line 66. From line 66, the heat sink fluid travels through line 68 towards a power source 70, such as an aircraft engine, or a secondary pump 72, such as a constant delivery fueldraulics pump, for circulating the heat sink fluid. The secondary pump 72 sends the heat sink fluid to a fluid control unit 76 through line 74. The fluid control unit 76 can selectively regulate the flow of heat sink fluid through line 78 into the condenser 40 or through line 80 to a load 82, such as a hydraulic cylinder. After the heat sink fluid passes through the load 82, the heat sink fluid travels through line 84 and connects with the heat sink fluid exiting the hydraulic motor 50 in line 54. The heat sink fluid in line 54 is throttled by valve 56 to a lower pressure prior to traveling through line 58 to connect with the heat sink fluid exiting the primary pump 64 in line 66.

FIG. 2 illustrates another example cooling system incorporating a vapor refrigerant cycle 122 similar to the example cooling system of FIG. 1 except as discussed below or shown in FIG. 2. A heat exchanger 145 receives a warm high-pressure refrigerant from line 126a and produces a sub-cooled high-pressure refrigerant exiting the heat exchanger 145 through line 126b. An expansion device 124 receives the sub-cooled high-pressure refrigerant from line 126b. The expansion device 124 restricts the flow of the sub-cooled high-pressure refrigerant to produce a low-pressure refrigerant exiting the expansion device 124 through line 128.

An evaporator 130 receives the low-pressure refrigerant from line 128. The evaporator 130 removes heat generated by avionics 32, acting as a heat exchanger. The avionics 32 include a first component 32a in electrical communication with a second component 32b. The first component 32a includes a motor controller or a power conditioning unit and the second component 32b includes a motor or a power generator, respectively. As the low-pressure refrigerant passes through the evaporator 130, the low-pressure refrigerant absorbs heat from the first component 32a. Heated low-pressure refrigerant exits the evaporator 130 through line 134a.

The heat exchanger 145 receives the heated low-pressure refrigerant from line 134a. Heat is transferred to the heated low-pressure refrigerant in line 134a from the warm high-pressure refrigerant in line 126a. A superheated low-pressure refrigerant exits the heat exchanger 145 through line 134b. The heat exchanger 145 allows for a lower operating temperature in the evaporator 130 while maintaining a higher condensing temperature.

The compressor 136 receives the superheated low-pressure refrigerant from line 134b to be pressurized. The compressor 136 is mechanically connected to the hydraulic motor 50 through the output shaft 52. The superheated high-pressure refrigerant exits the compressor 136 through line 138.

The condenser 140 receives the superheated high-pressure refrigerant from line 138 and acts as a heat exchanger. As the superheated high-pressure refrigerant in line 138 passes through the condenser 140, heat is transferred to a heat sink fluid, such as aircraft engine fuel, that passes through line 78 in the condenser 140. Warm high-pressure refrigerant exits the condenser 140 through line 142 and passes through a filter-dryer 144 to remove water from the warm high-pressure refrigerant before entering the heat exchanger 145 again.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. An aircraft cooling system comprising:
a refrigerant cycle, said refrigerant cycle including a first heat exchanger, a second heat exchanger, and a compressor;
at least one component of said aircraft to be in thermal communication with said first heat exchanger;
a heat sink fluid for passing through said second heat exchanger to absorb heat from said refrigerant cycle;
a hydraulic motor mechanically connected with said compressor to be powered by said heat sink fluid; and
a pump for circulating said heat sink fluid.

2. The system as set forth in claim 1, wherein said second heat exchanger is located downstream from said compressor.

3. The system as set forth in claim 1, wherein said heat sink fluid is aircraft engine fuel.

4. The system as set forth in claim 1, wherein a reservoir is fluidly connected to said pump for storing said heat sink fluid.

5. The system as set forth in claim 4, wherein said reservoir is a fuel tank.

6. The system as set forth in claim 4, wherein said pump transfers said heat sink fluid from said reservoir through said second heat exchanger.

7. The system as set forth in claim 1, wherein said heat sink fluid powers a load.

8. The system as set forth in claim 7, wherein said load is a hydraulic cylinder.

9. The system as set forth in claim 7, wherein a controller fluidly connects to said load and said second heat exchanger for selectively regulating the flow of said heat sink fluid.

10. The system as set forth in claim 1, wherein said refrigerant cycle includes a third heat exchanger for transferring heat from an inlet of said first heat exchanger to an outlet of said first heat exchanger.

11. The system as set forth in claim 1, wherein the refrigerant cycle is a vapor cycle.

12. The system as set forth in claim 1, wherein said at least one component is avionics.

13. An aircraft cooling system comprising
a vapor cycle, said vapor cycle including a condenser receiving a compressed refrigerant from a compressor, an expansion device downstream of said condenser, and refrigerant passing from said condenser to said expansion device into an evaporator;
at least one component of said aircraft in thermal communication with said evaporator;
a hydraulic motor mechanically connected with said compressor and powered by a heat sink fluid; and
a pump circulating said heat sink fluid from a reservoir.

14. The aircraft cooling system of claim 13, wherein said at least one component is avionics.

15. The aircraft cooling system of claim 13, wherein said heat sink fluid is aircraft engine fuel and said reservoir is a fuel tank.
